(19) United States
(12) Patent Application Publication
(10) Pub. No.: US 2025/0372846 A1
(43) Pub. Date: Dec. 4, 2025

(54) SECONDARY BATTERY

(71) Applicant: Samsung SDI Co., Ltd., Yongin-si (KR)

(72) Inventor: Taewoong Jang, Yongin-si (KR)

(73) Assignee: Samsung SDI Co., Ltd., Yongin-si (KR)

(21) Appl. No.: 18/926,169

(22) Filed: Oct. 24, 2024

(30) Foreign Application Priority Data
Jun. 4, 2024 (KR) 10-2024-0073338

(51) Int. Cl. H01M 50/588; H01M 50/153; H01M 50/181; H01M 50/184; H01M 50/188; H01M 50/559; H01M 50/595

(52) U.S. Cl. CPC H01M 50/588; H01M 50/153; H01M 50/181; H01M 50/184; H01M 50/188; H01M 50/559; H01M 50/595

(57) ABSTRACT

A secondary battery includes: an electrode assembly including a first and second electrodes; a case having an opening at one side and accommodating the electrode assembly; and a cap assembly sealing the opening of the case. The cap assembly may comprise a cap plate joined to one side of the case where the opening may be formed and having an insertion hole, a terminal plate including a body portion positioned between the cap plate and the electrode assembly, and an insertion portion protruding from the body portion through the insertion hole, the terminal plate being electrically connected to the first electrode and the case being electrically connected to the second electrode, and an insulating member extended and disposed over at least a portion of a top surface of the cap plate and at least a portion of a top surface of the terminal plate exposed through the insertion hole.

### CROSS-REFERENCE TO RELATED APPLICATIONS

This present application claims priority to and the benefit under 35 U.S.C. § 119(a)-(d) of Korean Patent Application No. 10-2024-0073338, filed on Jun. 4, 2024, in the Korean Intellectual Property Office, the entire disclosure of which is incorporated herein by reference.

### FIELD

Aspects of embodiments of the present disclosure relate to a secondary battery having an insulating member therein.

### BACKGROUND

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments of the present disclosure provide a secondary battery to solve the problems described herein.

These and other aspects and features of the present disclosure will be described in or will be apparent from the following description of embodiments of the present disclosure.

According to one or more embodiments of the present disclosure, a secondary battery includes: an electrode assembly including a first electrode and a second electrode; a case having an opening at one side and the case being for accommodating the electrode assembly; and a cap assembly sealing the opening of the case. The cap assembly may comprise a cap plate joined to one side of the case where the opening may be formed and the cap plate having an insertion hole, a terminal plate including a body portion positioned between the cap plate and the electrode assembly, and an insertion portion protruding from the body portion through the insertion hole of the cap plate, the terminal plate being electrically connected to the first electrode and the case being electrically connected to the second electrode, and an insulating member extended and disposed over at least a portion of a top surface of the cap plate and at least a portion of a top surface of the terminal plate that is exposed through the insertion hole.

In an embodiment, the insulating member may be further disposed on a side surface of the cap plate exposed by the insertion hole.

In an embodiment, the insulating member may extend up to the body portion of the terminal plate in the insertion hole.

In an embodiment, the cap assembly further may comprise an insulating layer between the cap plate and the body portion of the terminal plate.

In an embodiment, the insulating layer may have a hole through which the insertion portion of the terminal plate passes, and the insulating member may be further disposed on a side surface of the insertion hole and a side surface of the hole of the insulating layer.

In an embodiment, the insulating member may seal a space between the cap plate and the terminal plate in the insertion hole.

In an embodiment, the insulating member may include an extension portion filling a space surrounded by the terminal plate and the cap plate in the insertion hole when the terminal plate and the cap plate are joined.

In an embodiment, the extension portion may surround at least a portion of a side surface of the insertion portion.

In an embodiment, a thickness of the extension portion may be greater than thicknesses of other portions of the insulating member.

In an embodiment, the cap assembly may further comprise an insulating layer disposed between the cap plate and the body portion of the terminal plate, and a thickness of the extension portion may be equal to a thickness of the insulating layer.

In an embodiment, the cap assembly may further comprise an insulating layer disposed between the cap plate and the body portion of the terminal plate, and a thickness of the extension portion may be equal to a sum of a thickness of the cap plate and a thickness of the insulating layer.

In an embodiment, a thickness of the extension portion may be equal to a thickness between a top surface of the body portion of the terminal plate and a top surface of the insulating member.

In an embodiment, a thickness of the extension portion may be smaller than a thickness of the insertion portion of the terminal plate.

In an embodiment, an outer circumference of the insulating member may be spaced apart from an outer circumference of the cap plate by a predetermined distance.

In an embodiment, the predetermined distance may be 100 μm or more.

In an embodiment, the insulating member may be formed with an insulating tape adhered thereto.

In an embodiment, the insulating member may be formed with a coating solution comprising an insulating material applied thereto.

In an embodiment, the insulating layer may be comprise an adhesive material for bonding the cap plate or the terminal plate.

In an embodiment, the insertion portion of the terminal plate may protrude beyond the insulating member.

In an embodiment, the cap plate may be electrically connected to the second electrode, and the insulating member electrically may insulate the cap plate from the terminal plate.

According to embodiments of the present disclosure, the insulating member is spaced apart from the outer circumference of the cap plate by a predetermined distance. Therefore, it becomes possible to prevent the insulating member from being damaged by welding.

According to embodiments of the present disclosure, the region around the terminal plate within the insertion hole can be entirely covered by the insulating member. Therefore, by providing the insulating member, it becomes possible to prevent a short circuit between the cap plate and the terminal plate.

According to embodiments of the present disclosure, as an empty space between the terminal plate and the cap plate becomes smaller, it is possible to prevent conductive objects from being introduced between the terminal plate and the cap plate. In other words, as the thickness of the extension portion increases, the possibility of a short circuit occurring between the insertion part and the cap plate decreases.

According to embodiments of the present disclosure, the cap plate is protected by the insulating member, so that the external object cannot cause a short circuit between the terminal plate and the cap plate. Therefore, the secondary battery including such a configuration can be relatively safe as the risk of the short circuit is reduced.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a cross-sectional view of a secondary battery according to one embodiment of the present disclosure;

FIG. 2 is an exploded perspective view of a cap assembly according to one embodiment of the present disclosure;

FIG. 3 is a cross-sectional view of a cap assembly according to a first embodiment of the present disclosure;

FIG. 4 is a cross-sectional view of a cap assembly according to a second embodiment of the present disclosure;

FIG. 5 is a cross-sectional view of a cap assembly according to a third embodiment of the present disclosure;

FIG. 6 is a cross-sectional view of a cap assembly according to a fourth embodiment of the present disclosure;

FIG. 7 is a cross-sectional view of a cap assembly according to a fifth embodiment of the present disclosure; and

FIG. 8 illustrates an example of preventing a short circuit in a secondary battery.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

When assembling the components of a secondary battery, welding is commonly performed. However, welding the components of the secondary battery often results in welding detects, which can cause a short circuit in the secondary battery. In a case where an internal short circuit occurs due to an electrical contact between two different electrode materials in the secondary battery, a temperature of the secondary battery can be rapidly increased, potentially leading to severe consequences such as fire. Aspects of the technology described herein address such problems.

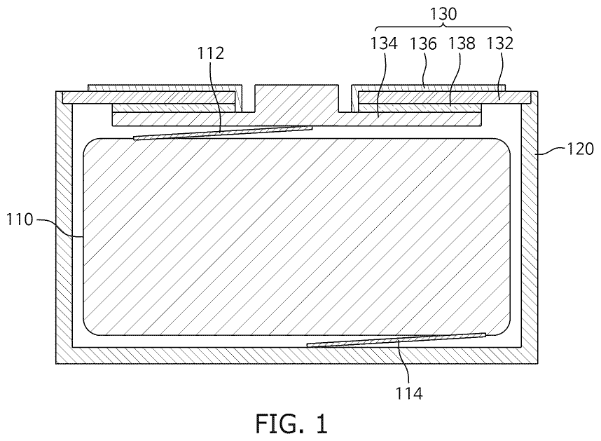

FIG. 1 illustrates a cross-sectional view of a secondary battery according to one embodiment of the present disclosure. FIG. 1 illustrates a cross-sectional view showing a structure in which a substantially cylindrical secondary battery is cut in a height direction thereof along a line crossing the center of the secondary battery. As shown in FIG. 1, the secondary battery may include an electrode assembly 110, a case 120, and a cap assembly 130.

The secondary battery may be a coin-type or button-type secondary battery. For example, the secondary battery may have a cylindrical shape. However, the shape of the secondary battery is not limited thereto, and the secondary battery may have a cylindrical shape, a prismatic shape, a pouch shape, or the like.

The electrode assembly 110 may include a first electrode, a second electrode, and a separator. Specifically, the electrode assembly 110 may be configured by winding the first and second electrodes together with the separator disposed between the first and second electrodes. The electrode assembly 110 may be wound to form a winding core and may include a through-hole in the winding core.

The first electrode may include a first substrate and a first active material layer applied onto the first substrate. A first electrode tab 112 may extend outward from a first uncoated portion of the first substrate where the first active material layer is not applied, and the first electrode tab 112 may be electrically connected to a terminal plate 134 of the cap assembly 130.

The second electrode may include a second substrate and a second active material layer applied onto the second substrate. A second electrode tab 114 may extend outward from a second uncoated portion of the second substrate where the second active material layer is not applied, and the second electrode tab 114 may be electrically connected to the case 120. The first electrode tab 112 and the second electrode tab 114 may respectively extend in opposite directions from each other.

In one embodiment, each of the first electrode tab 112 and the second electrode tab 114 may be covered with a cover tape. The cover tape may include an insulating material. The insulating material may provide electrical insulation to prevent current from passing therethrough. The cover tape may prevent a short circuit from occurring at the first electrode tab 112 and the second electrode tab 114.

The first electrode may serve as a positive electrode. In this case, the first substrate may be composed of, for example, aluminum foil, and the first active material layer may include, for example, a transition metal oxide. The second electrode may serve as a negative electrode. In this case, the second substrate may be composed of, for example, copper foil or nickel foil, and the second active material layer may include, for example, graphite.

The separator may function to prevent a short circuit between the first electrode and the second electrode while allowing movement of lithium ions. The separator may be composed of, for example, a polyethylene film, a polypropylene film, a polyethylene-polypropylene film, or the like, but the scope of the present disclosure is not limited thereto.

Referring to FIG. 1, the first electrode tab 112 of the first electrode may be formed on one side of the electrode assembly 110. The second electrode tab 114 of the second electrode may be formed on the other side of the electrode assembly 110. However, the scope of the present disclosure is not limited thereto. For example, the first electrode tab 112 and the second electrode tab 114 may be formed on one side of the electrode assembly 110.

The case 120 may accommodate the electrode assembly 110 and an electrolyte, and may form an external appearance of the secondary battery together with the cap assembly 130. The case 120 may include a substantially cylindrical sidewall portion and a bottom portion connected to one side of the sidewall portion. However, the case 120 is not limited thereto, and the case 120 may be configured in various shapes such as a circular shape, a pouch shape, or the like. In addition, the case may be composed of metal such as aluminum, an aluminum alloy, or nickel-plated steel, or a laminated film or plastic used for a pouch.

The case 120 may accommodate the electrode assembly 110. The electrode assembly 110 may be inserted into the case 120 through an opening formed at one side of the case 120. The opening of the case 120 may then be closed by the cap assembly 130. The cap assembly 130 may be joined to one side of the case 120.

The cap assembly 130 may include a cap plate 132, a terminal plate 134, an insulating member 136, and an insulating layer 138. Here, the cap plate 132 may seal the opening of the case 120. The cap plate 132 may be joined to a side surface of the case 120 corresponding to a side surface of the opening.

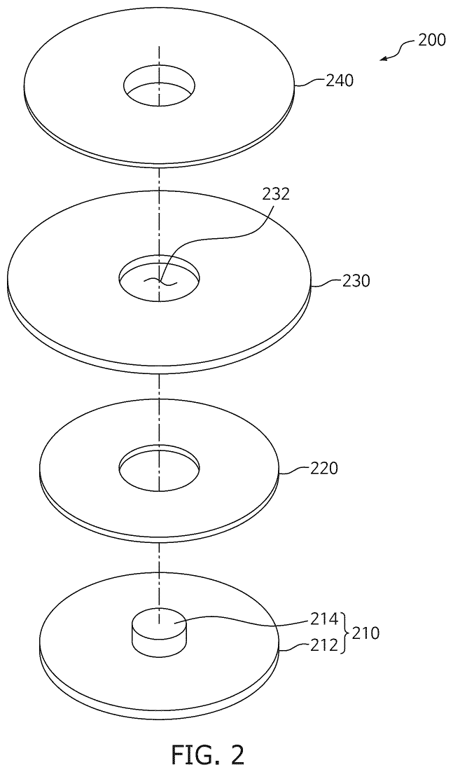

An insertion hole may be formed at the cap plate 132. Specifically, the insertion hole may be formed approximately at the center of the cap plate 132. The terminal plate 134 may be inserted into the insertion hole and joined to the cap plate 132. The terminal plate 134 may include a body portion disposed between the cap plate 132 and the electrode assembly 110 and an insertion portion protruding from the body portion. Here, the insertion portion of the terminal plate 134 may be inserted into the insertion hole of the cap plate 132. Further, the insertion portion of the terminal plate 134 may be connected to the first electrode tab 112 by contacting the first electrode tab 112. The body portion and the insertion portion of the terminal plate 134 will be described in more detail with reference to FIG. 2.

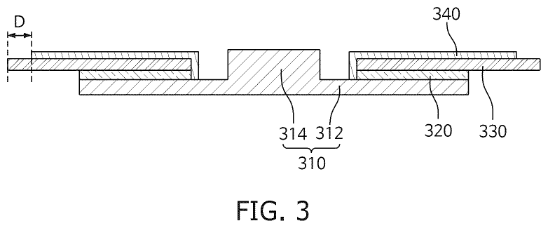

The insulating member 136 may be disposed over at least a portion of a top surface of the cap plate 132 and at least a portion of a top surface of the terminal plate 134 exposed through the insertion hole. Here, a bottom surface of the cap plate 132 may be a surface facing the electrode assembly 110 while the top surface of the cap plate 132 may be a surface opposite to the bottom surface of the cap plate 132. In one embodiment, the insulating member 136 may be made of an insulating material. Various embodiments of the insulating member 136 will be described in further detail with reference to FIGS. 3 to 7.

In one embodiment, the insulating member 136 may be formed with an insulating tape adhered thereto. Alternatively, the insulating member 136 may be formed with a coating solution containing an insulating material applied thereto. In another embodiment, a portion of the insulating member 136 may be formed with an insulating tape adhered thereto and a remaining portion of the insulating member 136 may be formed with a coating solution containing an insulating material applied thereto.

In one embodiment, the insulating layer 138 may be disposed between the terminal plate 134 and the cap plate 132. The insulating layer 138 may have adhesive properties to thereby bond the terminal plate 134 and the cap plate 132. The insulating layer 138 may include an adhesive material for bonding the terminal plate 134 and the cap plate 132. Alternatively, the insulating layer 138 may have adhesive layers respectively disposed on opposite surfaces to bond the terminal plate 134 and the cap plate 132 together. The insulating layer 138 may be formed of an insulating material to electrically insulate the terminal plate 134 and the cap plate 132 from each other.

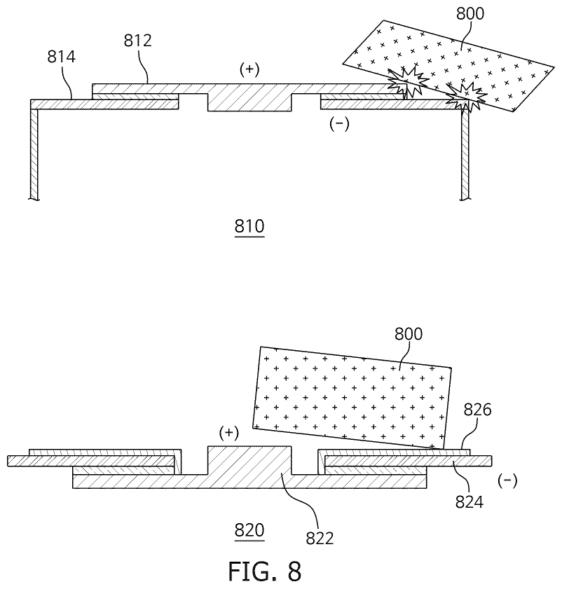

In one embodiment, the second electrode tab 114 may be connected to a bottom portion of the case 120. The case 120 may be connected to the cap plate 132, such that the second electrode may be electrically connected to the cap plate 132. The terminal plate 134 may be connected to the first electrode tab 112, such that the terminal plate 134 may be electrically connected to the first electrode. The insulating member 136 is positioned over at least a portion of the top surface of the cap plate 132 and also over at least a portion of the top surface of the terminal plate 134 exposed through the insertion hole. This arrangement may allow the insulating member 136 to insulate between the terminal plate 134 and the cap plate 132. The insulation provided by the insulating member 136 between the terminal plate 134 and the cap plate 132 will be described in more detail with reference to FIG. 8

FIG. 2 is an exploded perspective view of a cap assembly 200 according to one embodiment of the present disclosure. The cap assembly 200 shown in FIG. 2 may be the same as the cap assembly 130 of the secondary battery described in FIG. 1. FIG. 2 provides a more detailed description of the assembling relationship between the components included in the cap assembly 200.

Referring to FIG. 2, the cap assembly 200 may include a terminal plate 210, an insulating layer 220, a cap plate 230, and an insulating member 240. The terminal plate 210 may include a body portion 212 and an insertion portion 214 protruding from the body portion 212. The center of the insertion portion 214 may coincide with the center of the terminal plate 210.

In one embodiment, the body portion 212 may be positioned between the cap plate 230 and an electrode assembly within a case that accommodates the electrode assembly and is joined to the cap assembly 200. By connecting the body portion 212 to a first electrode tab, the terminal plate 210 may be electrically connected to a first electrode. In one embodiment, the insertion portion 214 may be connected to an external terminal (e.g., a positive-electrode external terminal).

In one embodiment, the insulating layer 220 may be disposed on the terminal plate 210. For example, a thickness of the insulating layer 220 may be smaller than a thickness of the insertion portion 214. The insulating layer 220 may have a hole formed at the center thereof, and the insertion portion 214 may pass through the hole of the insulating layer 220. A diameter of the hole of the insulating layer 220 may be larger than a diameter of the insertion portion 214.

The cap plate 230 may be joined to one side of the case where the opening is formed. The cap plate 230 may close and seal the opening of the case. The cap plate 230 may be disposed on the insulating layer 220 and positioned above the terminal plate 210. For example, a thickness of the cap plate 230 may be smaller than the thickness of the insertion portion 214.

In one embodiment, the cap plate 230 may have an insertion hole 232. The insertion hole 232 may be formed at the center of the cap plate 230. The insertion portion 214 of the terminal plate 210 may be inserted into the insertion hole 232. A diameter of the insertion hole 232 may be larger than the diameter of the insertion portion 214. As a result, at least a portion of the insertion portion 214 may be exposed through the insertion hole 232.

In one embodiment, the hole of the insulating layer 220 may face the insertion hole 232. The diameter of the hole of the insulating layer 220 may be the same as the diameter of the insertion hole 232. Alternatively, the diameter of the hole of the insulating layer 220 may be larger than the diameter of the insertion hole 232.

The insulating member 240 may be disposed on a top surface of the cap plate 230. The insulating member 240 may have a hole formed at the center thereof. The insertion portion 214 of the terminal plate 210 may be inserted into the hole of the insulating member 240.

In one embodiment, the insulating member 240 may have a protruding region extending downward from a bottom surface of the insulating member 240. Here, the bottom surface of the insulating member 240 may be a surface facing the cap plate 230. For example, an outer surface of the protruding region of the insulating member 240 may be disposed circumferentially on a side surface of the insertion hole 232 of the cap plate 230 (that is, the outer surface of the protruding region comes into contact with the side surface of the insertion hole 232). For example, the protruding region of the insulating member 240 may be disposed on at least a portion of the body portion 212.

In one embodiment, the thickness of the insertion portion 214 may be greater than the sum of the thickness of the insulating layer 220, the thickness of the cap plate 230, and the thickness of the insulating member 240. Here, the thickness of the insulating member 240 may refer to the thickness of a flat region of the insulating member 240. In this case, in the cap assembly 200 where the terminal plate 210, the insulating layer 220, the cap plate 230, and the insulating member 240 are assembled, the insertion portion 214 may protrude beyond the insulating member 240.

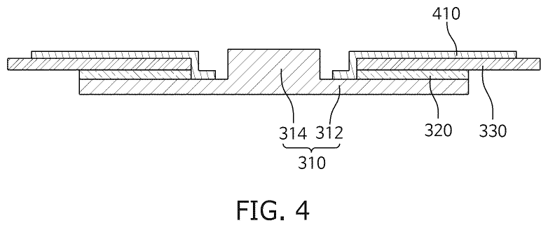

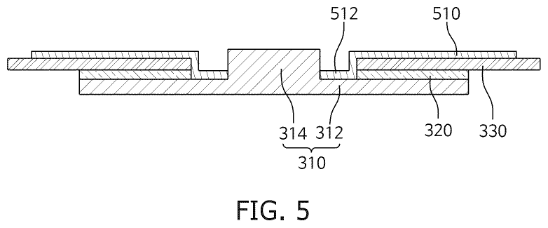

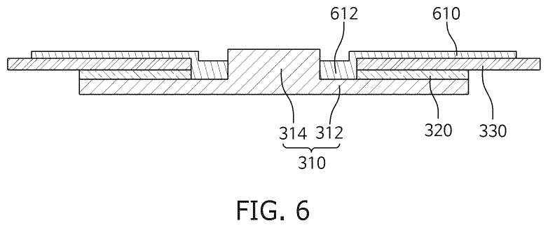

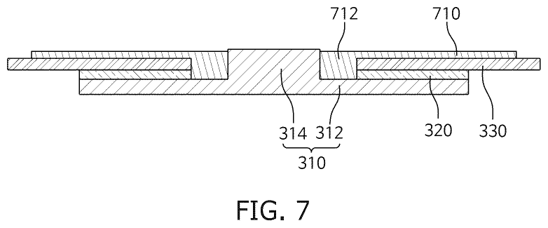

FIG. 3 is a cross-sectional view of a cap assembly according to a first embodiment of the present disclosure. FIG. 4 is a cross-sectional view of a cap assembly according to a second embodiment of the present disclosure. FIG. 5 is a cross-sectional view of a cap assembly according to a third embodiment of the present disclosure. FIG. 6 is a cross-sectional view of a cap assembly according to a fourth embodiment of the present disclosure. FIG. 7 is a cross-sectional view of a cap assembly according to a fifth embodiment of the present disclosure. The cap assembly according to each of the first embodiment to the fifth embodiment may be the same as the cap assembly 130 shown in FIG. 1 except for the insulating member. In other words, a terminal plate 310, an insulating layer 320, and a cap plate 330 shown in FIGS. 3 to 7 may be understood based on the description provided in FIG. 1. In FIGS. 3 to 7, the description will focus on the insulating member.

Referring to FIG. 3, an insulating member 340 may be disposed on at least a portion of the cap plate 330. In this case, an outer circumference of the insulating member 340 may be spaced apart from an outer circumference of the cap plate 330 by a predetermined distance. For example, an outer diameter of the insulating member 340 may be smaller than an outer diameter of the cap plate 330.

In one embodiment, the distance D between the outer circumference of the insulating member and the outer circumference of the cap plate may be about 100 μm or more. The outer circumference of the cap plate 330 may be joined to one side of the case. In this case, welding may be performed to join the cap plate 330 and the case. By spacing the insulating member 340 the predetermined distance from the outer circumference of the cap plate 330, the insulating member 340 may be prevented from being damaged by the welding process.

In one embodiment, the insulating member 340 may be further disposed on an inner surface of the cap plate 330. The insulating member 340 may be disposed on at least a portion of the top surface of the cap plate 330 may be extended along an inner surface of the cap plate 330 such that the extension portion of the insulating member 340 is positioned on the inner surface of the cap plate 330. Specifically, a portion of the insulating member 340 may be positioned on a side surface of an insertion hole of the cap plate 330. For example, the insulating member 340 may be positioned on a side surface of the cap plate exposed at the insertion hole. Here, the side surface of the insertion hole may face an insertion portion of the terminal plate 310.

In one embodiment, the insulating member 340 may be further disposed on an inner surface of the insulating layer 320. The insulating member 340 may be disposed on at least a portion of the top surface of the cap plate 330 may be further extended along an inner surface of the insulating layer 320 such that the extension portion of the insulating member 340 is positioned on the inner surface of the insulating layer 320. Specifically, a portion of the insulating member 340 may be disposed circumferentially on a side surface of the hole of the insulating layer 320. Here, the side surface of the hole of the insulating layer 320 may face the insertion portion of the terminal plate 310.

In one embodiment, the insulating member 340 may be disposed on at least a portion of the terminal plate 310. The insulating member 340 may be disposed over at least a portion of the top surface of the cap plate 330 and the side surfaces of the cap plate 330 and the insulating layer 320 may be further extended up to at least a portion of the terminal plate 310. In this case, the insulating member 340 may be extended up to a top surface of a body portion 312 of the terminal plate 310 in the insertion hole. The insulating member 340 may be disposed on at least a portion of the top surface of the body portion 312.

With the above-described configuration, the region around the terminal plate 310 within the insertion hole may be entirely covered by the insulating member 340. Therefore, the insulating member 340 may prevent a short circuit between the cap plate 330 and the terminal plate 310.

Referring to FIG. 4, an insulating member 410 may be an extension of the insulating member 340 shown in FIG. 3 (that is, the insulating member 410 may be obtained by horizontally extending a portion of the insulating member 340, which is positioned on the top surface of the body portion 312). The insulating member 410 may be extended and further disposed on at least a portion of the top surface of the body portion 312. For example, the insulating member 410 may be disposed on a portion of the body portion 312 exposed through the insertion hole.

Referring to FIG. 5, an insulating member 510 may be an extension of the insulating member 410 shown in FIG. 4 (that is, the insulating member 510 may be obtained by extending a portion of the insulating member 410, which is positioned on the top surface of the body portion 312). The insulating member 510 may be further extended and disposed on the body portion 312 exposed through the insertion hole. As a result, the entire body portion 312 exposed through the insertion hole may be covered by the insulating member 510.

In one embodiment, the insulating member 510 may include an extension portion 512 that fills a space surrounded by the terminal plate 310 and the cap plate 330. In a case where the insulating layer 320 is disposed between the terminal plate 310 and the cap plate 330, the extension portion 512 may fill the space surrounded by the terminal plate 310, the insulating layer 320, and the cap plate 330.

In one embodiment, the extension portion 512 may surround at least a portion of a side surface of an insertion portion 314. As a thickness of the extension portion 512 increases, the area of the side surface of the insertion portion 314 that is surrounded by the extension portion 512 may become larger. For example, the thickness of the extension portion 512 may be greater than the thicknesses of other portions of the insulating member 510. As another example, the thickness of the extension portion 512 may be smaller than or equal to the thicknesses of other portions of the insulating member 510. As yet another example, the thickness of the extension portion 512 may be the same as the thickness of the insulating layer 320. These structures allow the insulating member 510 to seal a space (e.g., a gap) between the cap plate 330 and the terminal plate 310 in the insertion hole.

Referring to FIG. 6, an insulating member 610 may be obtained by increasing the thickness of the extension portion 512 of the insulating member 510 shown in FIG. 5. The insulating member 610 has an extension portion 612, and a thickness of the extension portion 612 may be greater than a thickness of the insulating layer 320. The thickness of the extension portion 612 may be equal to or similar to the sum of the thickness of the insulating layer 320 and the thickness of the cap plate 330. With the above-described structure, as the empty space between the terminal plate 310 and the cap plate 330 becomes smaller, it is possible to prevent conductive objects from being introduced between the terminal plate 310 and the cap plate 330.

Referring to FIG. 7, an insulating member 710 may be obtained by increasing the thickness of the extension portion 612 of the insulating member 610 shown in FIG. 6. The insulating member 710 may have an extension portion 712, and a thickness of the extension portion 712 may be the same as a thickness between the top surface of the body portion 312 and a top surface of the insulating member 710. Further, the thickness of the extension portion 712 may be smaller than the thickness of the insertion portion 314. The insulating member 710 may be formed by a coating solution containing an insulating material.

As shown in FIGS. 3 to 7, as the insulating member extends and the thickness of the extension portion increases, the possibility of a short circuit occurring between the insertion part 314 and the cap plate 330 may decrease.

FIG. 8 illustrates an example of preventing a short circuit in a secondary battery. A first example 810 may illustrate a configuration of a cap assembly that is joined to a case. In the cap assembly of the first example 810, no insulating member is present in the secondary battery, and an insertion portion of a terminal plate 812 faces an electrode assembly. The cap assembly may include the terminal plate 812 connected to a positive electrode and a cap plate 814 connected to a negative electrode. The cap assembly may include an insulating layer disposed between the terminal plate 812 and the cap plate 814. The insulating layer may prevent a short circuit between the terminal plate 812 and the cap plate 814.

In the first example 810, an external object 800 may come into contact with the cap assembly. In this case, if the external object 800 is a conductive object, a short circuit may occur between the terminal plate 812 and the cap plate 814 even though an insulating layer is present. Alternatively, even when the external object 800 impacts the cap assembly, a short circuit may also occur between the terminal plate 812 and the cap plate 814.

A second example 820 may represent an example of the same configuration as the cap assembly described with reference to FIG. 3. A terminal plate 822 may be connected to a positive electrode, and a cap plate 824 may be connected to a negative electrode. An insulating member 826 may be disposed over at least a portion of the cap plate 824 and at least a portion of the terminal plate 822.

In the second example 820, the external object 800 may come into contact with the cap assembly. In this case, even if the external object 800 is a conductive object, the cap plate 824 is protected by the insulating member 826, so that the external object 800 may not cause a short circuit between the terminal plate 822 and the cap plate 824. Therefore, the secondary battery according to embodiments of the present disclosure can be relatively safe as the risk of the short circuit is reduced.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiaA1-bXbO2-cDc (0.90≤a≤1.8, 0≤b≤0.5, 0≤c≤0.05); LiaMn2-bXbO4-cDc (0.90≤a≤1.8, 0≤b≤0.5, 0≤c≤0.05); LiaNi1-b-cCobXcO2-αDα (0.90≤a≤1.8, 0≤b≤0.5, 0≤c≤0.5, 0<α<2); LiaNi1-b-cMnbXcO2-αDα (0.90≤a≤1.8, 0≤b≤0.5, 0≤c≤0.5, 0<α<2); LiaNibCocL1dGeO2 (0.90≤a≤1.8, 0≤b≤0.9, 0≤c≤0.5, 0≤d≤0.5, 0≤e≤0.1) ; LiaNiGbO2 (0.90≤a≤1.8, 0.001≤b≤0.1); LiaCoGbO2 (0.90≤a≤1.8, 0.001≤b≤0.1); LiaMn1-bGbO2 (0.90≤a≤1.8, 0.001≤b≤0.1); LiaMn2GbO4 (0.90≤a≤1.8, 0.001≤b≤0.1); LiaMn1-gGgPO4 (0.90≤a≤1.8, 0≤g≤0.5); Li(3-f)Fe2(PO4)3 (0≤f≤2); and LiaFePO4 (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and combinations thereof but is not limited thereto.

The organic material and the inorganic material may be mixed in one coating layer or may be in the form of a coating layer containing an organic material and a coating layer containing an inorganic material that are laminated on each other.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
an electrode assembly including a first electrode and a second electrode;
a case having an opening at one side and the case being for accommodating the electrode assembly; and
a cap assembly sealing the opening of the case,
wherein the cap assembly comprises:
a cap plate joined to one side of the case where the opening is formed and the cap plate having an insertion hole;
a terminal plate including a body portion positioned between the cap plate and the electrode assembly, and an insertion portion protruding from the body portion through the insertion hole of the cap plate, the terminal plate being electrically connected to the first electrode and the case being electrically connected to the second electrode; and
an insulating member extended and disposed over at least a portion of a top surface of the cap plate and at least a portion of a top surface of the terminal plate that is exposed through the insertion hole.

2. The secondary battery as claimed in claim 1, wherein the insulating member is further disposed on a side surface of the cap plate exposed by the insertion hole.

3. The secondary battery as claimed in claim 2, wherein the insulating member extends up to the body portion of the terminal plate in the insertion hole.

4. The secondary battery as claimed in claim 1, wherein the cap assembly further comprises an insulating layer between the cap plate and the body portion of the terminal plate.

5. The secondary battery as claimed in claim 4, wherein the insulating layer has a hole through which the insertion portion of the terminal plate passes, and
the insulating member is further disposed on a side surface of the insertion hole and a side surface of the hole of the insulating layer.

6. The secondary battery as claimed in claim 1, wherein the insulating member seals a space between the cap plate and the terminal plate in the insertion hole.

7. The secondary battery as claimed in claim 1, wherein the insulating member includes an extension portion filling a space surrounded by the terminal plate and the cap plate in the insertion hole when the terminal plate and the cap plate are joined.

8. The secondary battery as claimed in claim 7, wherein the extension portion surrounds at least a portion of a side surface of the insertion portion.

9. The secondary battery as claimed in claim 7, wherein a thickness of the extension portion is greater than thicknesses of other portions of the insulating member.

10. The secondary battery as claimed in claim 7, wherein the cap assembly further comprises an insulating layer disposed between the cap plate and the body portion of the terminal plate, and
a thickness of the extension portion is equal to a thickness of the insulating layer.

11. The secondary battery as claimed in claim 7, wherein the cap assembly further comprises an insulating layer disposed between the cap plate and the body portion of the terminal plate, and
a thickness of the extension portion is equal to a sum of a thickness of the cap plate and a thickness of the insulating layer.

12. The secondary battery as claimed in claim 7, wherein a thickness of the extension portion is equal to a thickness between a top surface of the body portion of the terminal plate and a top surface of the insulating member.

13. The secondary battery as claimed in claim 7, wherein a thickness of the extension portion is smaller than a thickness of the insertion portion of the terminal plate.

14. The secondary battery as claimed in claim 1, wherein an outer circumference of the insulating member is spaced apart from an outer circumference of the cap plate by a predetermined distance.

15. The secondary battery as claimed in claim 14, wherein the predetermined distance is 100 μm or more.

16. The secondary battery as claimed in claim 1, wherein the insulating member is formed with an insulating tape adhered thereto.

17. The secondary battery as claimed in claim 1, wherein the insulating member is formed with a coating solution comprising an insulating material applied thereto.

18. The secondary battery as claimed in claim 4, wherein the insulating layer comprises an adhesive material for bonding the cap plate or the terminal plate.

19. The secondary battery as claimed in claim 1, wherein the insertion portion of the terminal plate protrudes beyond the insulating member.

20. The secondary battery as claimed in claim 1, wherein the cap plate is electrically connected to the second electrode, and the insulating member electrically insulates the cap plate from the terminal plate.
